(19) United States
(12) Patent Application Publication
(10) Pub. No.: US 2024/0241885 A1
(43) Pub. Date: Jul. 18, 2024

(54) DYNAMIC DATA COLLECTION

(71) Applicant: International Business Machines Corporation, Armonk, NY (US)

(72) Inventors: Fan Jing Meng, Beijing (CN); Guang Han Sui, Beijing (CN); Peng Hui Jiang, Beijing (CN); Xing Tian, Beijing (CN); Li Jian Wang, Beijing (CN); Cheng Fang Wang, Beijing (CN); Hua Ye, Beijing (CN); Ming Liang Zu, Beijing (CN); Jun Su, Beijing (CN)

(21) Appl. No.: 18/155,242

(22) Filed: Jan. 17, 2023

(51) Int. Cl. G06F 16/2458; G06F 16/2455

(52) U.S. Cl. CPC G06F 16/2477; G06F 16/24564

(57) ABSTRACT

Disclosed embodiments provide techniques for dynamic data collection. The dynamic data collection includes determining a data generation temporal pattern. Based on the data generation temporal pattern, a data collection strategy is created. The data collection strategy can be based on one or more data collection goals. The data collection strategy can contain specific details on how data is to be collected. A data infrastructure evaluation is performed, which provides pricing models for resources such as electricity and/or network bandwidth. A data collection policy is created based on the data collection strategy and the data infrastructure evaluation. The data collection policy can contain specific details on when data is to be collected and what strategy to use for the collection. A data transfer schedule is created based on the data collection policy. The data transfer schedule determines when to collect data from one or more data source devices.

### FIELD

The present invention relates generally to computer systems, and more particularly, to dynamic data collection.

### BACKGROUND

As technology has advanced, the number of low-cost, network-connected, data-producing devices has increased dramatically. This has resulted in a considerable increase in the amount of data generated, and thus needing to be parsed, analyzed, and/or stored. These devices commonly include Internet of Things (IoT) devices. IoT generally refers to the process of connecting physical objects to the Internet. IoT can include systems of physical devices or hardware that receive and transfer data over networks in an automated manner. A typical IoT system works by continuously sending, receiving, and analyzing data in a feedback loop. Analysis of that data can be conducted either manually or by artificial intelligence and machine learning (AI/ML), in near real-time or over a longer period. The data can be used in a wide variety of applications. These include meteorological applications, vehicular traffic applications, monitoring applications, and more. Collection of this data is an important prerequisite for performing the analysis.

### SUMMARY

In an embodiment, there is provided a computer-implemented method for data transfer, comprising: determining a data generation temporal pattern; creating a data collection strategy based on the data generation temporal pattern; generating a data collection policy based on the data collection strategy and a data infrastructure evaluation; and creating a data transfer schedule for transfer of data from one or more data source devices to a data store based on the data collection policy.

In another embodiment, there is provided an electronic computation device comprising: a processor; a memory coupled to the processor, the memory containing instructions, that when executed by the processor, cause the electronic computation device to: determine a data generation temporal pattern; create a data collection strategy based on the data generation temporal pattern; generate a data collection policy based on the data collection strategy and a data infrastructure evaluation; and create a data transfer schedule for transfer of data from one or more data source devices to a data store based on the data collection policy.

In yet another embodiment, there is provided a computer program product for an electronic computation device comprising a computer readable storage medium having program instructions embodied therewith, the program instructions executable by a processor to cause the electronic computation device to: determine a data generation temporal pattern; create a data collection strategy based on the data generation temporal pattern; generate a data collection policy based on the data collection strategy and a data infrastructure evaluation; and create a data transfer schedule for transfer of data from one or more data source devices to a data store based on the data collection policy.

### BRIEF DESCRIPTION OF THE DRAWINGS

FIG. 1 is an exemplary computing environment in accordance with disclosed embodiments.

FIG. 2 is an exemplary ecosystem in accordance with disclosed embodiments.

FIG. 3 is a block diagram indicating modules of a dynamic data collection scheduler in accordance with embodiments of the present invention.

FIG. 4 is an example of temporal data.

FIG. 5A shows an example of temporospatial data at a first time.

FIG. 5B shows an example of temporospatial data at a second time.

FIG. 6 is a flowchart indicating process steps for embodiments of the present invention.

FIG. 7 is an exemplary strategy configuration file in accordance with embodiments of the present invention.

FIG. 8 is an exemplary policy configuration file in accordance with embodiments of the present invention.

FIG. 9 is a block diagram of a data source device in accordance with disclosed embodiments.

FIG. 10 is an exemplary configuration user interface in accordance with embodiments of the present invention.

FIG. 11 is an exemplary data collection alert in accordance with embodiments of the present invention.

FIG. 12 is an exemplary data collection alert including a recommendation in accordance with embodiments of the present invention.

The drawings are not necessarily to scale. The drawings are merely representations, not necessarily intended to portray specific parameters of the invention. The drawings are intended to depict only example embodiments of the invention, and therefore should not be considered as limiting in scope. In the drawings, like numbering may represent like elements. Furthermore, certain elements in some of the Figures may be omitted, or illustrated not-to-scale, for illustrative clarity.

### DETAILED DESCRIPTION

Data is one of the most important assets in the information era. Data can be generated from many computerized devices including sensors, cloud applications, edge computing, as well as mobile devices such as smartphones, wearable computers, and the like. Data is collected from the source and sent to the destinations where the data is consumed, managed, processed, stored and/or archived. This requires considerable energy and computing resources, such as electricity and network bandwidth.

Disclosed embodiments provide techniques for dynamic data collection. The dynamic data collection includes determining a data generation temporal pattern. This can include determining and/or predicting when peak data generation occurs. Based on the data generation temporal pattern, a data collection strategy is created. The data collection strategy can be based on one or more data collection goals. The data collection strategy can contain specific details on how data is to be collected. A data infrastructure evaluation is performed, which provides pricing models for resources such as electricity and/or network bandwidth. A data collection policy is created based on the data collection strategy and the data infrastructure evaluation. The data collection policy can contain specific details on when data is to be collected and what strategy to use for the collection. A data transfer schedule is created based on the data collection policy. The data transfer schedule determines when to collect data from one or more data source devices.

Reference throughout this specification to “one embodiment,” “an embodiment,” “some embodiments”, or similar language means that a particular feature, structure, or characteristic described in connection with the embodiment is included in at least one embodiment of the present invention. Thus, appearances of the phrases “in one embodiment,” “in an embodiment,” “in some embodiments”, and similar language throughout this specification may but do not necessarily, all refer to the same embodiment.

Moreover, the described features, structures, or characteristics of the invention may be combined in any suitable manner in one or more embodiments. It will be apparent to those skilled in the art that various modifications and variations can be made to the present invention without departing from the spirit and scope and purpose of the invention. Thus, it is intended that the present invention cover the modifications and variations of this invention provided they come within the scope of the appended claims and their equivalents. Reference will now be made in detail to the preferred embodiments of the invention.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. The term “set” is intended to mean a quantity of at least one. It will be further understood that the terms “comprises” and/or “comprising”, or “includes” and/or “including”, or “has” and/or “having”, when used in this specification, specify the presence of stated features, regions, integers, steps, operations, elements, and/or components, but do not preclude the presence or addition of one or more other features, regions, or elements.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

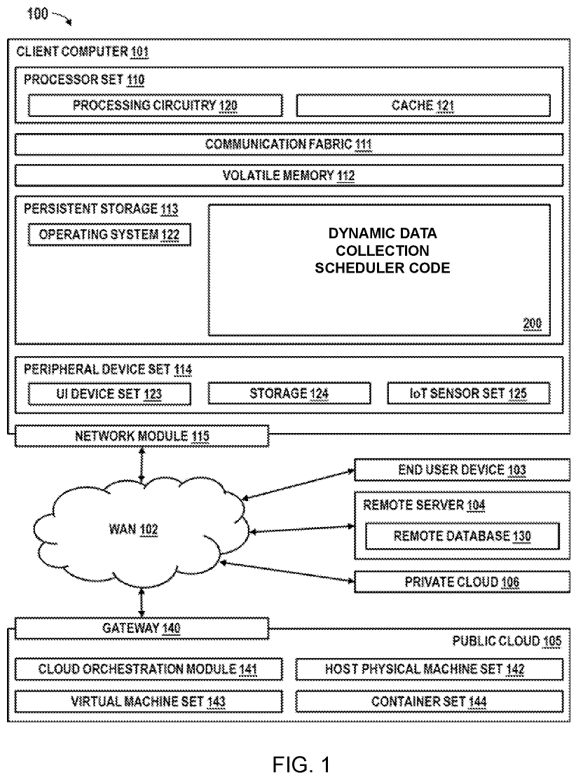

FIG. 1 shows an exemplary computing environment 100 in accordance with disclosed embodiments. Computing environment 100 contains an example of an environment for the execution of at least some of the computer code involved in performing the inventive methods, such as dynamic data collection scheduler code block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

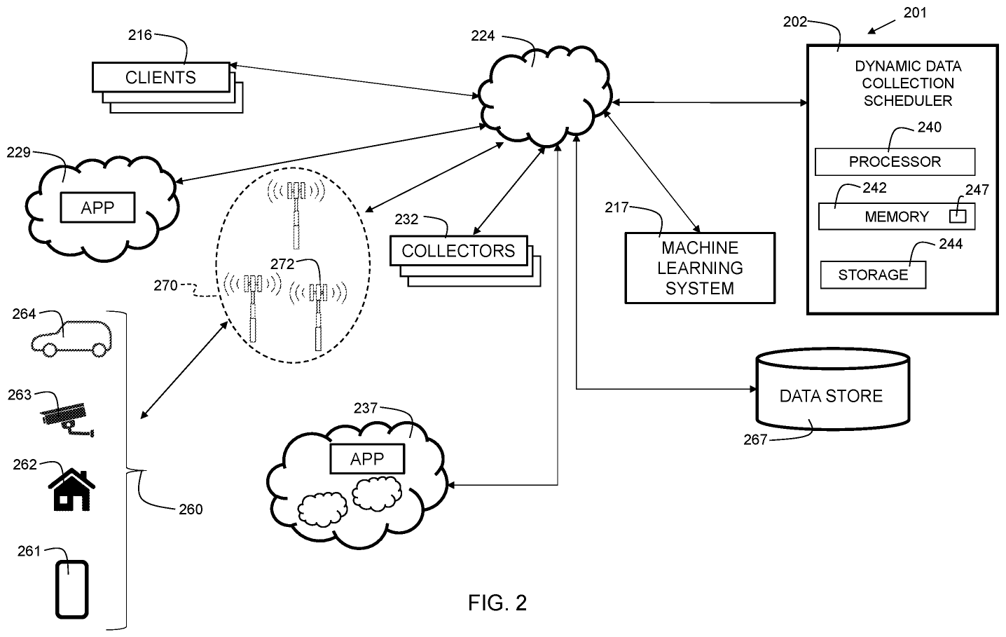

FIG. 2 is an exemplary ecosystem 201 in accordance with disclosed embodiments. Dynamic Data Collection Scheduler (DDCS) 202 comprises a processor 240, a memory 242 coupled to the processor 240, and storage 244. DDCS 202 is an electronic computation device. The memory 242 contains program instructions 247, that when executed by the processor 240, perform processes, techniques, and implementations of disclosed embodiments. Memory 242 may include dynamic random-access memory (DRAM), static random-access memory (SRAM), magnetic storage, and/or a read only memory such as flash, EEPROM, optical storage, or other suitable memory, and should not be construed as being a transitory signal per se. In some embodiments, storage 244 may include one or more magnetic storage devices such as hard disk drives (HDDs). Storage 244 may additionally include one or more solid state drives (SSDs). The DDCS 202 is configured to interact with other elements of ecosystem 201. DDCS 202 is connected to network 224, which is the Internet, a wide area network, a local area network, or other suitable network.

Ecosystem 201 may include one or more client devices, indicated as 216. Client device 216 can include a laptop computer, desktop computer, tablet computer, or other suitable computing device. Client device 216 may be used to configure DDCS, including features such as specifying data collection (data transfer and/or data aggregation) strategies and policies.

Ecosystem 201 may include machine learning system 217. The machine learning system 217 can include, but is not limited to, a convolutional neural network (CNN), Support Vector Machine (SVM), Decision Tree, Recurrent Neural Network (RNN), Long Short Term Memory Network (LSTM), Radial Basis Function Network (RBFN), Multilayer Perceptron (MLP), and/or other suitable neural network type. In embodiments, the machine learning system 217 is trained using supervised learning techniques. In disclosed embodiments, the machine learning system 217 may be used for predicting data generation temporal and/or temporospatial patterns.

Ecosystem 201 may include data source devices 260. The data source devices 260 can include edge devices. A variety of data source devices can participate in ecosystem 201, including mobile communication devices 261, which can include smartphones. The data source devices can include premises devices 262. The premises devices 262 can include environmental sensors, such as temperature sensors, humidity sensors, motion sensors, and so on. The data source devices can include camera devices 263. The camera devices 263 can include surveillance cameras, infrared cameras, webcams, and so on. The data source devices can include peripheral devices within vehicles 264. The peripheral devices within vehicles 264 can include onboard devices that generate data including, but not limited to, location data, velocity data, direction data, operating parameters such as engine parameters, battery charge level, and so on. Other types of data source devices may also be included in data source devices collectively indicated as 260. The data in the data source devices 260 may be sent to data store 267 for storage. The fetching of the data from the data source devices 260 may be orchestrated by one or more collectors 232. Collectors 232 can be comprised of one or more computers, virtual machines, and/or containerized applications. The collectors 232 may receive instructions and/or configurations from DDCS 202 to collect data from data source devices 260 in a way that is most efficient from a cost and/or computer resource standpoint, while still enabling data collection so that the data can be analyzed. Ecosystem 201 may further include edge cloud application 229 and/or hybrid cloud application 237. These applications may also produce data that needs to be collected and stored in data store 267.

Data store 267 may include one or more storage devices, and or database repositories. The database repositories can include SQL databases, mongoDB, and/or other suitable database schemas and/or storage formats. The data store 267 may include raw data. The raw data is data received from data source devices 260 and/or executing in edge cloud application 229 and/or hybrid cloud application 237.

Ecosystem 201 may further include a radio access network 270 comprising multiple towers, indicated generally as 272. Each tower may have a corresponding base station that can provide functionality such as processing radio signals, detecting errors, performing security functions, and/or load balancing. The base stations may convert the radio signals into electrical signals for communication over a computer network, utilizing protocols such as ethernet, TCP/IP, UDP, and the like. The base stations may communicate with a backhaul system and/or switching center to facilitate communication to other proprietary communication networks. These systems may implement one or more virtual network functions (VNFs), or portions thereof. The virtual network functions can include, but are not limited to, routing functions, firewall functions, orchestration, video analytics, security functions, and others. The radio access network 270 can provide cellular network connectivity, and may include an LTE (Long Term Evolution) cellular network, 5G cellular network, or other suitable cellular network. The radio access network 270 can be used to retrieve data from data source devices 260, enabling the data to be routed to, and stored in, data store 267, where it can be further processed and/or analyzed by other remote computing devices.

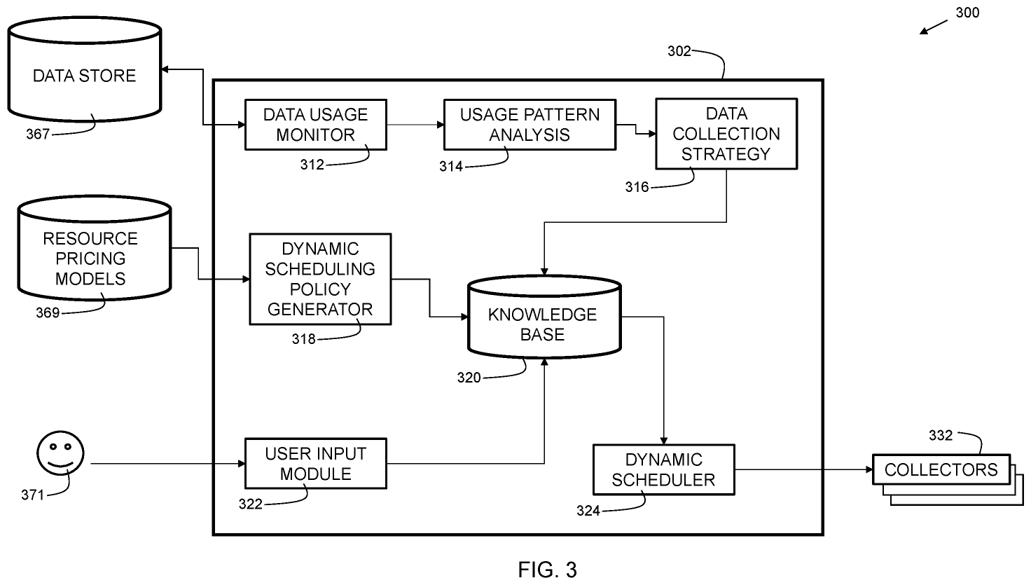

FIG. 3 is a block diagram 300 indicating modules of a dynamic data collection scheduler 302 in accordance with embodiments of the present invention. In some embodiments, dynamic data collection scheduler 302 may be similar to dynamic data collection scheduler 202 of FIG. 2. In some embodiments, dynamic data collection scheduler 302 may be implemented via one or more computers, virtual machines, and/or containerized applications. Dynamic data collection scheduler 302 includes a data usage monitor 312. The data usage monitor 312 can include functions and instructions for monitoring data use from data store 367. While one data store is shown in FIG. 3, in practice the dynamic data collection scheduler 302 can interface with multiple data stores. The data usage monitor can measure computer performance metrics such as bandwidth usage, throughput, latency, packet loss, retransmission rates, availability, and/or connectivity.

Dynamic data collection scheduler 302 includes a usage pattern analysis module 314. The usage pattern analysis module 314 can include functions and instructions for determining a temporal and/or temporospatial pattern of data generation. This can include determining a periodicity and/or statistical pattern based on heuristics, curve fitting, or other suitable technique. In some embodiments, the usage pattern analysis module 314 can include machine learning algorithms and/or interface with a machine learning system such as machine learning system 217 of FIG. 2.

Dynamic data collection scheduler 302 includes a data collection strategy module 316. The data collection strategy module 316 can include functions and instructions for determining and/or specifying details of how to collect data. This can include, but is not limited to, a rate at which a data generating device is polled, an address of a data generating device, a method of retrieval of data from a generating device, as well as other constraints and/or parameters. Dynamic data collection scheduler 302 includes a knowledge base 320. The knowledge base 320 can include digital information and/or data structures pertaining to data collection strategies and scheduling policies. The knowledge base may support adding, deleting, and editing strategies and policies.

Dynamic data collection scheduler 302 includes a dynamic scheduling policy generator 318. The dynamic scheduling policy generator 318 can include functions and instructions for receiving resource pricing models 369. The resource pricing models can include pricing models, schedules, and/or rates for resources such as electricity, network bandwidth, and the like. The pricing schedules can include tiers of service. The pricing can be dynamic. As an example, electricity pricing can vary over the course of a day, week, season, etc. Similarly, network bandwidth can have a cost per megabyte that varies over the course of a day, week, season, etc. Additionally, service tiers can have various price differences. As an example, a 40 Mbps (megabits per second) upstream service may have a higher price than a 10 Mbps service. The dynamic scheduling policy generator 318 can determine which time(s) may be most cost effective for data collection based on the resource pricing models 369.

Dynamic data collection scheduler 302 includes a dynamic scheduling policy generator 318. The dynamic scheduling policy generator 318 can include functions and instructions for receiving user preferences from a user 371. Embodiments can include receiving one or more user preferences. The user input module 322 can contain instructions and/or functions for receiving input from a user 371. The user preferences can include determining collection constraints and/or parameters based on a semantic priority. Some applications necessitate time-critical data transfer. As an example, meteorological data used for weather forecasting may need to be collected within five minutes, in order to be useful for a forecast. In contrast, vehicle traffic sensor data used to measure monthly vehicle traffic across a bridge may not need to be sent as frequently. In that case, if the data is not as time-critical, it may be held locally, and then sent overnight, when electricity and/or network bandwidth rates may be cheaper. The user input module 322 can enable a user to specify various constraints and options for data collection.

Dynamic data collection scheduler 302 includes a dynamic scheduler 324. The dynamic scheduler 324 can include functions and instructions for communicating with the collectors 332 for performing the actual data collection. The collectors 332 may be similar to collectors 232 of FIG. 2. The dynamic scheduler 324 can interact with the collectors 332 via API (application programming interface) function calls, such as remote procedure calls (RPC), execution of RESTful APIs, and/or other suitable techniques.

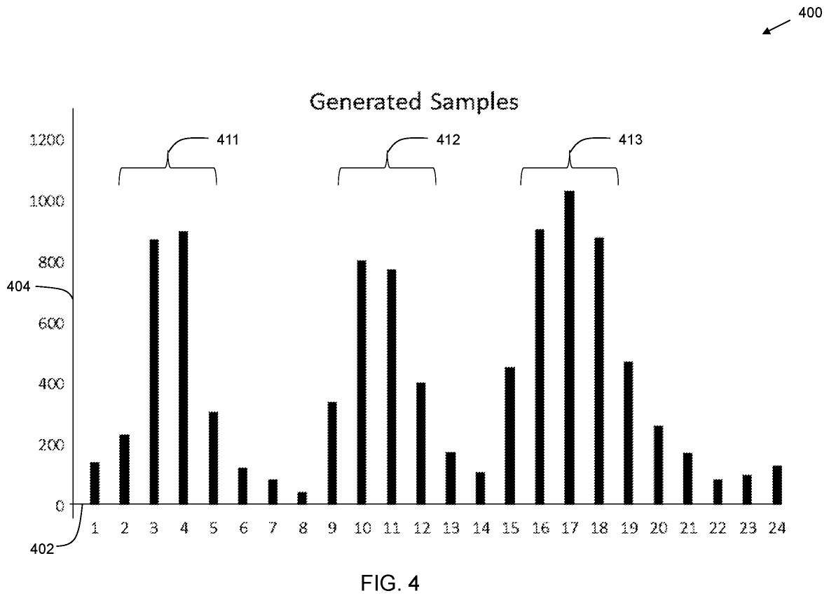

FIG. 4 is an example 400 of temporal data. Example 400 includes a graph of data samples generated by a data source device such as shown at 260 in FIG. 2. The horizontal axis 402 represents units of time. The units of time can be milliseconds, seconds, minutes, hours, days, weeks, months, years, or other suitable time interval. In embodiments, the temporal pattern includes at least one of monthly, weekly, daily, and hourly. The vertical axis 404 represents numbers of samples per collection cycle. In embodiments, approximately periodic increase zones, indicated as 411, 412, and 413 can be identified via identification of local maxima, curve fitting, and/or other suitable techniques. By identifying peak times and data amounts, an appropriate data collection strategy and/or data collection policy can be assessed. As an example, if the peak data is below a certain threshold, then a lower-cost data tier may be suitable for data collection.

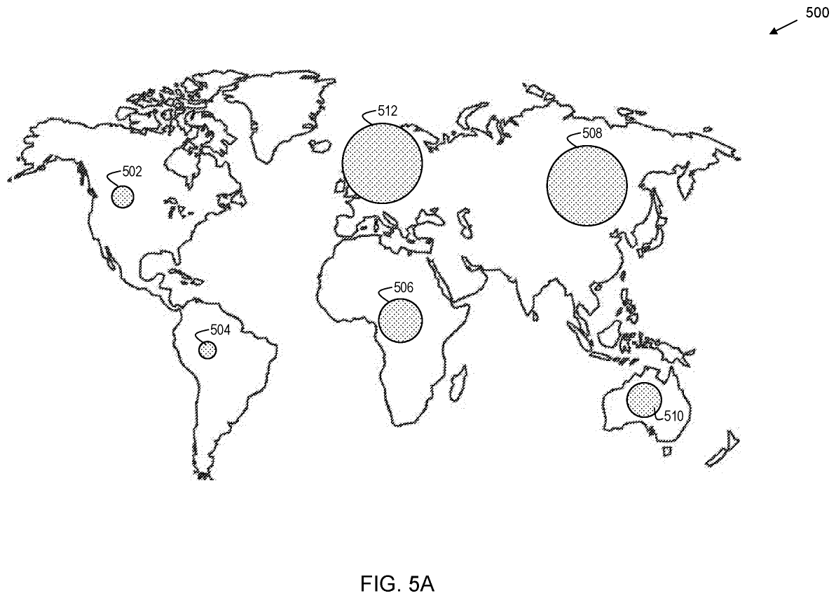

FIG. 5A shows an example 500 of temporospatial data at a first time. Example 500 shows a geographical map, where the amount of data generated by region is visualized via circles of different sizes, where the size of the circle is proportional to an amount of data generated within a given region. As an example, circle 502 represents data generated in North America, circle 504 represents data generated in South America, circle 506 represents data generated in Africa, circle 508 represents data generated in Asia, circle 510 represents data generated in Australia, and circle 512 represents data generated in Europe. The data shown in FIG. 5A is for a given instance in time, referred to as time t1. As an example, time t1 can be 10:00 UTC. FIG. 5B shows an example 550 of temporospatial data at a second time, referred to as time t2. As an example, time t2 can be 22:00 UTC. In a manner similar to as represented in FIG. 5A, in FIG. 5B, circle 552 represents data generated in North America, circle 554 represents data generated in South America, circle 556 represents data generated in Africa, circle 558 represents data generated in Asia, circle 560 represents data generated in Australia, and circle 562 represents data generated in Europe. In comparing FIG. 5A, and FIG. 5B, it can be seen that the amount of data generated in North America increased between time t1 and time t2, indicated by circle 552 in FIG. 5B being larger than circle 502 in FIG. 5A. Additionally, in comparing FIG. 5A, and FIG. 5B, it can be seen that the amount of data generated in Asia decreased between time t1 and time t2, indicated by circle 558 in FIG. 5B being smaller than circle 508 in FIG. 5A. Thus, the change in data indicated in FIG. 5A and FIG. 5B varies in both time and space, thereby forming a temporospatial pattern. As an example, during nighttime hours where a majority of people are asleep, a source of data may be reduced, and conversely, during hours of the day where a majority of people are awake, a source of data may be increased. The behavior of data is application specific. Some data may be generated more based on a season (e.g., during cold weather, warm weather, etc.). Regardless of the specific behavior, a temporospatial pattern can be used to derive and/or select strategies and/or policies for efficient data collection. Embodiments can include determining a data generation temporospatial pattern, and the data collection strategy can be based on the data generation temporospatial pattern.

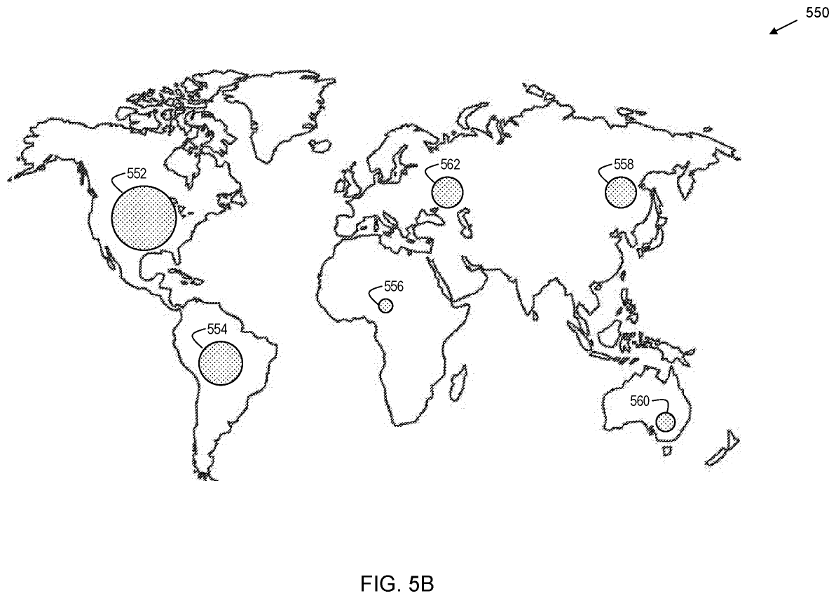

FIG. 6 is a flowchart 600 indicating process steps for embodiments of the present invention. At 602, a temporal pattern is determined. The temporal pattern can be approximately periodic, such as depicted in FIG. 4. In some embodiments, the temporal pattern may be aperiodic. In some embodiments, the temporal pattern may be determined/predicted through a combination of historical data generation analysis and machine learning techniques. In embodiments, a machine learning system is trained via supervised learning on previously generated data patterns. The previously generated data patterns can include data generated in previous time periods, such as previous weeks, months, and/or years. The generated data patterns can include peak data amounts, in terms of messages, bytes, and/or other suitable units of measure.

At 604, a data collection strategy is created. The data collection strategy can include specific details of how to collect data. This can include, but is not limited to, a rate at which a data generating device is polled, an address of a data generating device, a method of retrieval of data from a generating device, as well as other constraints and/or parameters.

At 606, a data collection policy is created. The data collection strategy can include specific details of when to collect data, and what strategy to use. The strategy can be dynamic. The policy can specify multiple strategies. For example, a first strategy can be selected for the months of January to May while a second strategy is selected for months of June through August and then a third strategy can be selected for the months of September through December This can accommodate data generation patterns that have a seasonal correlation. For example, meteorological data such as rainfall or snowfall can correlate to certain months of the year. With disclosed embodiments, a first policy can be used during seasons where that meteorological data is critical, and a second policy can be used during seasons where that meteorological data is less critical, allowing a savings of computer and/or energy resources during those less critical time intervals.

The data collection policy can be based on a data infrastructure evaluation 608. The data infrastructure evaluation 608 can include receiving pricing models for resources. This can include receiving an electricity pricing model 631. The electricity pricing model 631 can include power supply rates from one or more electricity suppliers. The electricity pricing model 631 can include Time of Use (TOU) rates. Time of Use rates are a kind of electricity billing arrangement in which the price of electricity changes based on the time of day. TOU rates make electricity more expensive during “peak hours,” when there is high demand, and less expensive during hours of low demand. In cases where the data supplied by data source devices 260 is not time-critical, the data collection policy can include deferring data collection until the electricity rate is at a lower price than during the peak hours. The electricity pricing model 631 may utilize a meteorological model 637 for determination of electricity pricing, as electricity demand can fluctuate based on weather conditions, temperature, and more.

The data infrastructure evaluation 608 can include receiving a bandwidth pricing model 633. The bandwidth pricing model 633 can include data rates for communication over a computer network. The computer network can include a radio access network (RAN). The RAN can include a cellular network, such as an LTE network, 5G network, or the like. In some cases, the data rates may fluctuate during time of day, day of week, and/or other criterion. In cases where the data supplied by data source devices 260 is not time-critical, the data collection policy can include deferring data collection until the network data rate is at a lower price than during the peak hours. In embodiments, the data infrastructure evaluation includes obtaining an electricity pricing model and/or obtaining a bandwidth pricing model.

The data infrastructure evaluation 608 can include receiving user preferences 610. In embodiments, the data collection policy is based on the user preferences. The user preferences can specify various data collection options and/or strategy preferences. Strategies can include, but are not limited to, fastest, oldest, newest, and cheapest. In a fastest strategy, data is collected as quickly as possible from the data source devices 260 and sent to the data store 267 (FIG. 2). In an oldest strategy, the oldest data generated is the first data that is collected from the data source devices 260 and sent to the data store 267 (FIG. 2). Thus, this strategy serves as a first-in-first-out (FIFO) strategy. In a newest strategy, the newest data generated is the first data that is collected from the data source devices 260 and sent to the data store 267 (FIG. 2). Older data may be sent after the newer data is sent. This strategy can be used for “bursty” data that generates large amounts of data in a short time, followed by a longer duration of little or no data generation, allowing the older data to be sent. Thus, this strategy serves as a last-in-first-out (LIFO) strategy. In a cheapest strategy, data is collected as economically as possible from the data source devices 260 and sent to the data store 267 (FIG. 2). The decisions regarding when and how to send the data depend on the information that is received and processed to generate the data collection policy.

The user preferences can further include one or more data collection options. The data collection options can include an option to compress data prior to data collection. The compression can be lossless data compression or lossy data compression, depending on the application. Media such as audio and images can be well-suited for lossy data compression, while binary data and text data may be better suited for lossless data compression. The data collection options can include an option to allow sampling. In sampling mode, the data collection may include collecting a sampling of all available data, up to a predetermined amount of data. With this option set, it is not necessary to collect all available data. This option can be well-suited for crowdsourcing applications. As an example, in collecting data from mobile devices such as 261 (FIG. 2) for a pedestrian flow study, a subset of the available data that is generated may be sufficient for performing the desired analysis. In these situations, the sampling option can be used to conserve energy and/or computing resources. The data collection options can include an option to select a maximum delay factor. The maximum delay factor can be used for time-sensitive data. As an example, if data needs to be collected within two hours, a two-hour delay factor can be specified. The delay factor allows the collection to be deferred, up to two hours. Continuing with this example, if deferring data collection for 45 minutes would reduce the data collection cost, then the data collection can be deferred. If instead, the data collection would need to be deferred for 225 minutes in order to obtain a cost savings, then the data collection is performed within the two-hour delay factor, foregoing the cost savings, since the data is indicated as having a time-critical component. Thus, in certain situations, the maximum delay factor option can be used to conserve energy and/or computing resources. The data collection options can include an option to set a data limit. The data limit can be based on a time interval such as an hour, day, week, etc. This can be useful where the amount of available data can vary. Examples include data based on human behavior, such as number of people visiting a particular area. The data limit can be used to prevent unexpected overage charges from excess network bandwidth usage.

The data infrastructure evaluation 608 can include determining and/or receiving a temporospatial pattern at 612. A temporospatial pattern includes variations in data generation in both time and space, such as illustrated in FIG. 5A and FIG. 5B. Applications including meteorological monitoring and forecasting, vehicular traffic studies, and more, can have a strong correlation to a temporospatial pattern. By using the temporospatial pattern as a criterion for data collection, improved efficiency in terms of electricity and/or computer resource usage can be achieved.

At 614, a data transfer schedule is created. The data transfer schedule is created based on the data collection policy generated at 606. At 616, the collectors are configured, based on the data transfer schedule. The process may then periodically return to 602 to repeat the process. In this way, as conditions change, such as energy prices, network data rates, and so on, the data collection policies and data transfer schedules can update accordingly. Embodiments can include changing the data transfer schedule in response to detecting a change in the data infrastructure evaluation. In some embodiments, an alert may be issued at 624. The alert can include information regarding a change in the data collection pricing, scheduling, and/or other factors. The alert may be rendered by an application (app) on a client device such as 216 (FIG. 2), and/or disseminated as an email, text message, or other suitable technique.

In some embodiments, a recommendation may be generated at 622. The recommendation can include information regarding a recommended policy and/or strategy change based on pricing, scheduling, and/or other factors. The recommendation can be derived from a what-if analysis performed by the Dynamic Data Collection Scheduler (DDCS) 202 (FIG. 2). The recommendation may be rendered by an application (app) on a client device such as 216 (FIG. 2), and/or disseminated as an email, text message, or other suitable technique.

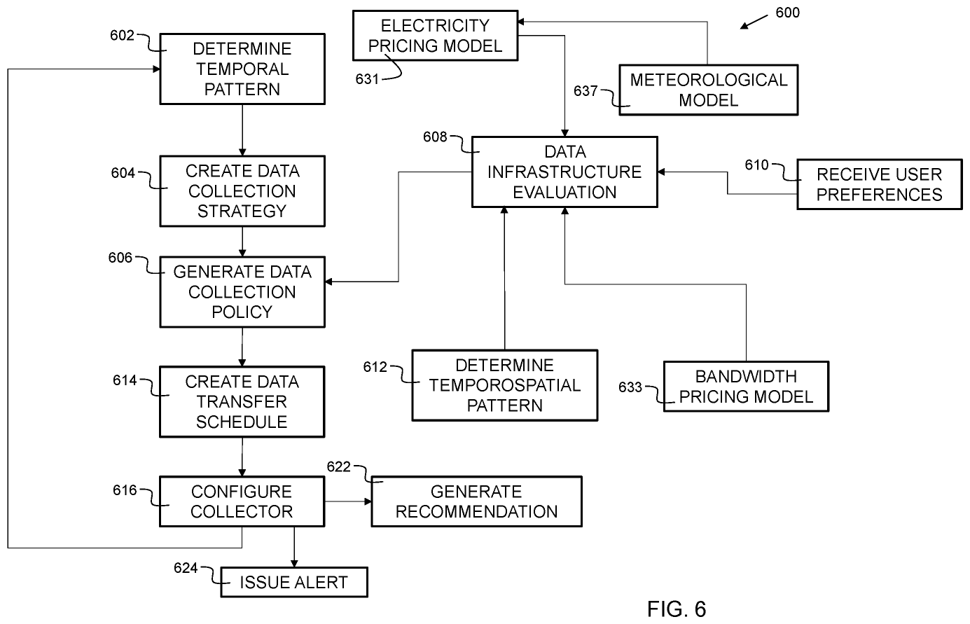

FIG. 7 is an exemplary strategy configuration file 700 in accordance with embodiments of the present invention. The formats for strategy configuration files can include, but are not limited to, yaml, XML, CSV, JSON, script files, or other suitable formats. At 702, there is a ‘name’ field that indicates a name for the strategy. At 704, there is an ‘interval’ field that includes a data collection interval. At 706, there is a ‘unit’ field for indicating the units of the value in the interval field at 704. In embodiments, the units can include, but are not limited to, milliseconds (ms), seconds, minutes, hours, days, and weeks. At 707, there is an action name field. The action name allows a convenient naming of an action to be taken to perform data collection. At 708, there is an action field. The action field can include a command, script, binary program, HTTP function, and/or other suitable functions for performing the data collection. At 710, there is an option for data sampling. At 712, there is an option for a size limit. At 714, there is an option for the maximum chunk bytes, which is the maximum number of bytes for a single data collection instance. At 716, there is an option for a grace period. The grace period can specify how long the data may be deferred before it is collected. In embodiments, the grace period can be a number of seconds, minutes, hours, days, or other suitable time unit. At 718, there is an option for data compression. In embodiments, this may be set true to perform a data compression operation prior to sending the data to the data store 267 (FIG. 2). In some cases, the compress option may be set false. This may be used for types of data that do not compress well. In this case, the data collection can be more efficient without compression, since the compression in these situations does not offer much benefit, the time and processor cycles needed to perform compression can be eliminated, improving overall data collection efficiency. These are merely exemplary, and more, fewer, and/or different parameters may be included in the strategy configuration file in some embodiments.

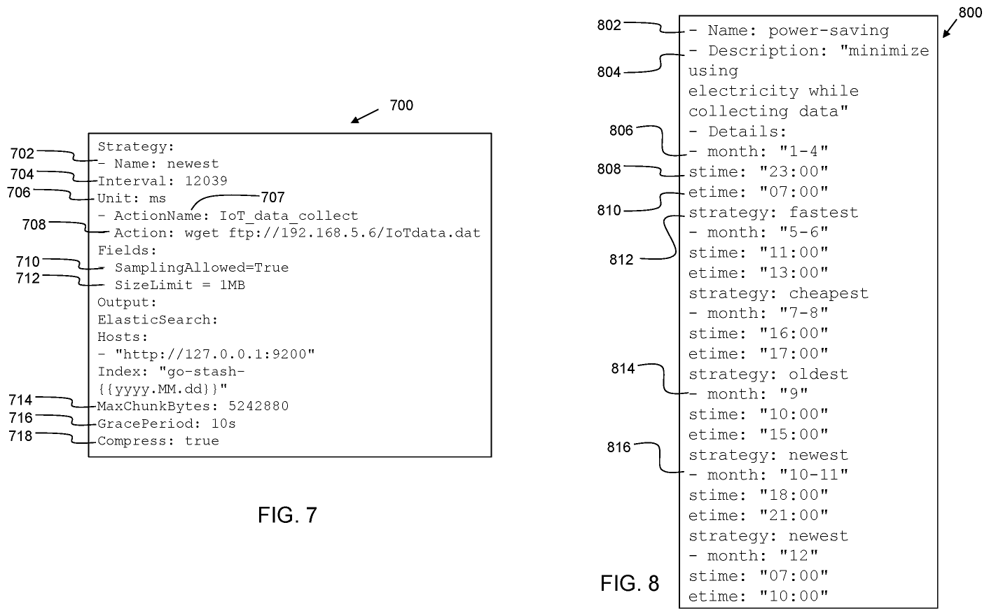

FIG. 8 is an exemplary policy configuration file 800 in accordance with embodiments of the present invention. The formats for policy configuration files can include, but are not limited to, yaml, XML, CSV, JSON, script files, or other suitable formats. In the example shown in FIG. 8, file 800 includes a ‘name’ field 802 that indicates a name for the policy. At 804, there is a ‘description field that indicates a text description for the data collection policy. At 806, there is a ‘month’ field that can specify a single month, multiple months, and/or a range of months. Shown at 806, the month field is specified as the range “1-4” which indicates January through April At 808, there is a start time field (stime) that indicates a starting time for the data collection cycle. At 810, there is an end time field (etime) that indicates an ending time for the data collection cycle. In some embodiments, any data that is not collected by the end time may be handled according to the strategy and/or policy configuration options. Based on the selected options, the uncollected data may be discarded, or collected during the next collection cycle. At 812, there is a strategy specified for use during the data collection cycle. The strategy may be specified by a strategy configuration file such as shown at 700 in FIG. 7. As can be seen, there can be multiple sections to a data collection policy. For example, at 814, there is a section pertaining to month 9 (September), and, at 816, there is a section pertaining to months 10-11 (October and November). These are merely exemplary, and more, fewer, and/or different parameters may be included in the policy configuration file in some embodiments.

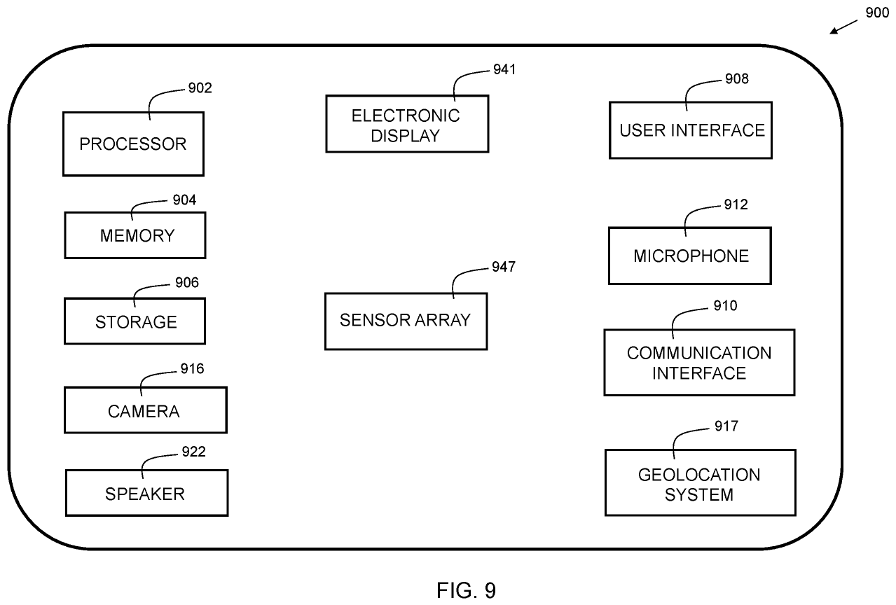

FIG. 9 is a block diagram of a data source device 900 in accordance with disclosed embodiments. In embodiments, this may represent an electronic device such as that indicated at 261, 262, 263, and/or 264 of FIG. 2. Device 900 is an electronic computation device. Device 900 includes a processor 902, which is coupled to a memory 904. Memory 904 may include dynamic random-access memory (DRAM), static random-access memory (SRAM), magnetic storage, and/or a read only memory such as flash, EEPROM, optical storage, or other suitable memory. In some embodiments, the memory 904 may not be a transitory signal per se. In some embodiments, device 900 may be a smartphone, or other suitable electronic computing device. In some embodiments, device 900 may be an IoT sensor, such as a motion sensor, moisture sensor, temperature sensor, or other sensing device. In some embodiments, device 900 may be networked digital camera such as a security camera, webcam, or other suitable digital camera. In some embodiments, device 900 may be a vehicular peripheral device such as a position sensor, electronic toll transponder, autonomous vehicle log data transmitter, or other suitable vehicular peripheral device.

Device 900 may further include storage 906. In embodiments, storage 906 may include one or more magnetic storage devices such as hard disk drives (HDDs). Storage 906 may additionally include one or more solid state drives (SSDs). Device 900 may in some embodiments, include a user interface 908. This may include an electronic display 941, keyboard, or another suitable interface. In some embodiments, the display 941 may be touch-sensitive. In some embodiments, the device 900 may be “headless” and not include any user interface or display.

The device 900 further includes a communication interface 910. The communication interface 910 may include a wired interface such as Ethernet. The communication interface 910 may include a wireless communication interface that includes modulators, demodulators, and antennas for a variety of wireless protocols including, but not limited to, Bluetooth™, Bluetooth™ Low Energy (BLE), Wi-Fi, and/or cellular communication protocols for communication over a computer network. In embodiments, instructions are stored in memory 904. The instructions, when executed by the processor 902, cause the electronic computing device 900 to execute operations in accordance with disclosed embodiments.

Device 900 may further include a microphone 912 used to receive audio input. The audio input may be digitized by circuitry within the device 900. The digitized audio data may be analyzed patterns indicative of something to be measured, such as ambient noise, a traffic pattern, etc. Device 900 may further include sensor array 947. The sensor array can include one or more sensors that generate data to be collected and sent to the data store 267 (FIG. 2). These sensors can include, but are not limited to, temperature sensors, humidity sensors, accelerometers, light sensors, sound sensors, radio frequency sensors, motion sensors, wind sensors, and the like.

Device 900 may further include camera 916. In embodiments, camera 916 may be used to acquire still images and/or video images by device 900. Device 900 may further include one or more speakers 922. In embodiments, speakers 922 may include stereo headphone speakers, and/or other speakers. Device 900 may further include geolocation system 917. In embodiments, geolocation system 917 includes a Global Positioning System (GPS), GLONASS, Galileo, or other suitable satellite navigation system. These components are exemplary, and other devices may include more, fewer, and/or different components than those depicted in FIG. 9.

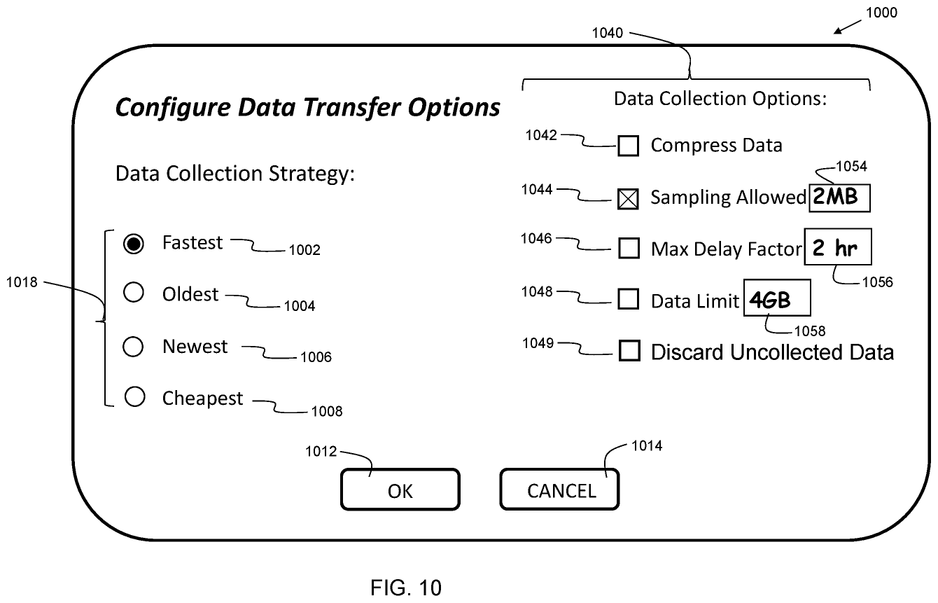

FIG. 10 is an exemplary configuration user interface 1000 in accordance with embodiments of the present invention. The user interface 1000 can include one or more data collection strategy options 1018. The data collection strategy options can include fastest 1002, oldest 1004, newest 1006, and/or cheapest 1008. In embodiments, a radio button, or other suitable user interface element is used to specify a data collection strategy.

The user interface 1000 can include one or more data collection options 1040. The data collection strategy options can include data compression 1042, sampling 1044, maximum delay factor 1046, and/or data limit 1048. A text field 1054 enables input of a sampling data size to be used when the sampling option is selected. A text field 1056 enables input of a maximum delay factor to be used when the maximum delay factor option is selected. A text field 1058 enables input of a data limit value when the data limit option is selected. In embodiments, checkboxes, or another suitable user interface element is used to specify one or more data collection options. In the example of FIG. 10, the checkbox for the sampling option 1044 is selected, while the other checkboxes are in an unselected state. Embodiments may further include a data collection strategy option to discard uncollected data 1049. When invoked, this option discards data that was not able to be collected in a given data collection cycle. For example, when the amount of generated data exceeds the amount that could be transferred in a given data collection cycle, the uncollected data can be discarded, or instead can be collected in a subsequent data collection cycle, based on the selection of the option at 1049.

Embodiments can include enabling editing of the data strategy by a user. The editing can enable selection of a fasted data strategy, newest data strategy, oldest data strategy, or cheapest data strategy. In embodiments, the user preferences include a maximum delay factor, data compression option, data sampling option, and/or a data size option. In some embodiments, the options may include a data sampling frequency and number of data samples per data collection cycle. In user interface 1000, a user can invoke the OK button 1012 to accept the configuration, or alternatively can invoke the cancel button 1014 to discard any configuration changes that were made since the last time the configuration was saved.

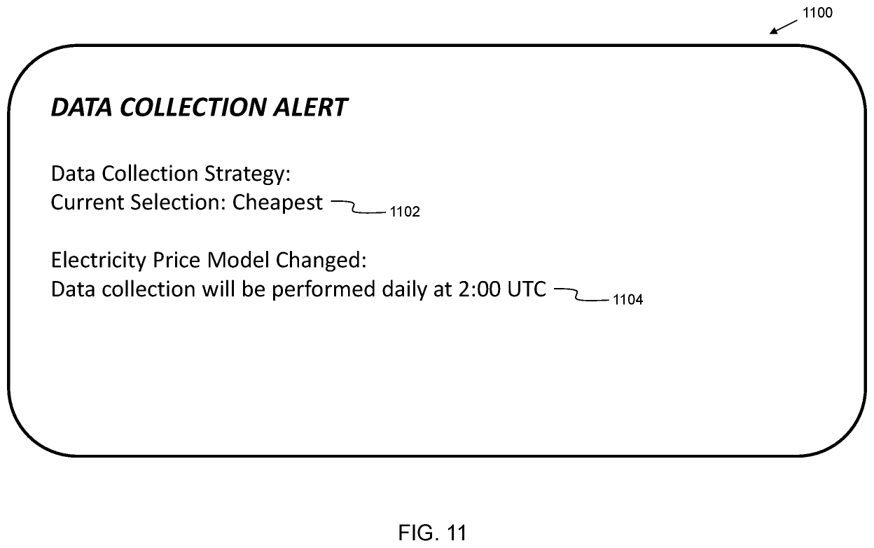

FIG. 11 is an exemplary data collection alert 1100 in accordance with embodiments of the present invention. In embodiments, when a change in data collection pricing and/or schedule occurs due to changing pricing models, an alert can be sent to a stakeholder such as a system administrator, manager, or the like. At 1102, a current strategy is shown. This indicates the data collection strategy currently being used. At 1104, an alert message is shown. The alert message can indicate a change in data collection times, data collection pricing, and/or other relevant data collection parameters. Embodiments can include issuing an alert in response to the changing of the data transfer schedule.

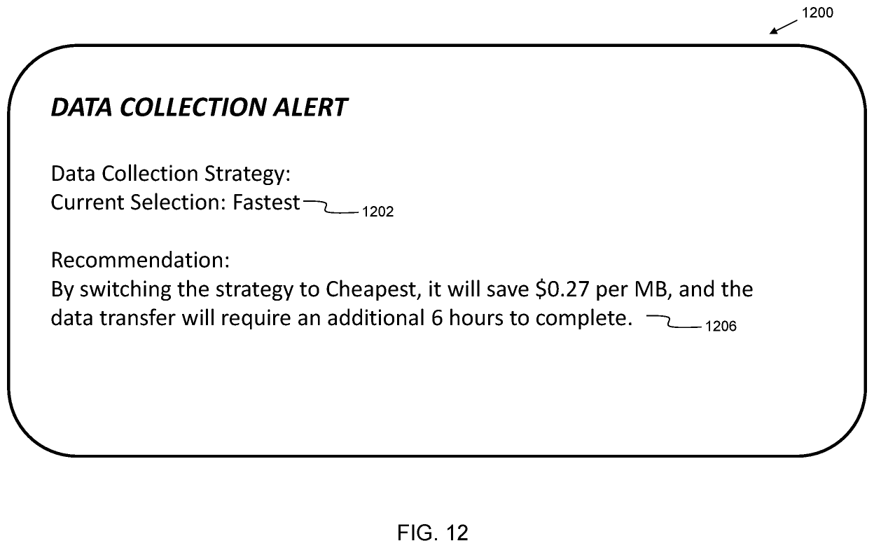

FIG. 12 is an exemplary data collection alert 1200 including a recommendation 1206 in accordance with embodiments of the present invention. At 1202, a current strategy is shown. This indicates the data collection strategy currently being used. As shown in FIG. 12, the current strategy selected is fastest. In a fastest strategy, data is collected as quickly as possible from the data source devices 260 and sent to the data store 267 (FIG. 2). The fastest strategy may not necessarily be the most cost-effective data collection strategy.

Disclosed embodiments can perform a what-if analysis. The what-if analysis can perform an evaluation of how the uncertainty in the output of a model or system can be linked to different sources of uncertainty in its inputs. Generally, the what-if analysis can be used to test the robustness of the results of a model or system in the presence of uncertainty to better understand the relationships between input and output variables in a system or model. The what-if analysis can also be used to identify errors in the pricing models through unexpected relationships between inputs and outputs. The what-if analysis may further be used for model simplification by eliminating model inputs that have no significant effect on the output, as well as to identify and remove redundant parts of the model structure. In embodiments, the what-if analysis can compute the data collection costs and data collection times for one or more data collection strategies besides the strategy that is currently selected as indicated at 1202. As an example, the what-if analysis can compute the data collection costs and data collection times for the newest, oldest, and cheapest data collection strategies previously described. Based on the outcome of the what-if analysis, a recommendation 1206 can be rendered, which can indicate pricing and/or data transfer/collection times if a different strategy were to be used. In this way, stakeholders can be informed of possible optimizations, and change the data collection strategies and/or policies when it is feasible.

As can now be appreciated, disclosed embodiments provide a novel data collection technique with smart and dynamic scheduling for saving resources. Disclosed embodiments factor in usage awareness. Embodiments can discover data usage patterns and prioritize data for an intended collection purpose. Disclosed embodiments also take complex resource pricing into consideration, factoring in the dynamic pricing of resources including electricity, bandwidth, cloud services, and the like. Additionally, disclosed embodiments provide an evolvement mechanism, allowing the data collection strategy and scheduling policies to evolve over time and adapt to changing business and/or infrastructure conditions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for data transfer, comprising:
determining a data generation temporal pattern;
creating a data collection strategy based on the data generation temporal pattern;
generating a data collection policy based on the data collection strategy and a data infrastructure evaluation; and
creating a data transfer schedule for transfer of data from one or more data source devices to a data store based on the data collection policy.

2. The method of claim 1, wherein the data generation temporal pattern includes at least one of monthly, weekly, daily, and hourly.

3. The method of claim 1, further comprising receiving one or more user preferences.

4. The method of claim 3, wherein the user preferences include a maximum delay factor.

5. The method of claim 3, wherein the user preferences include a data compression option.

6. The method of claim 3, wherein the user preferences include a data sampling option.

7. The method of claim 6, wherein the data sampling option includes a data size.

8. The method of claim 3, wherein the user preferences include a data limits option.

9. The method of claim 3, wherein the data collection policy is based on the user preferences.

10. The method of claim 1, further comprising determining a data generation temporospatial pattern, and wherein the data collection strategy is based on the data generation temporospatial pattern.

11. The method of claim 1, further comprising: enabling editing of the data collection strategy.

12. The method of claim 11, wherein the editing enables selection of a fastest data strategy.

13. The method of claim 11, wherein the editing enables selection of a newest data strategy.

14. The method of claim 11, wherein the editing enables selection of a cheapest data strategy.

15. The method of claim 1, wherein the data infrastructure evaluation includes obtaining an electricity pricing model.

16. The method of claim 15, wherein the data infrastructure evaluation includes obtaining a bandwidth pricing model.

17. The method of claim 16, further comprising: changing the data transfer schedule in response to detecting a change in the data infrastructure evaluation.

18. The method of claim 17, further comprising: issuing an alert in response to the changing of the data transfer schedule.

19. An electronic computation device comprising:
a processor;
a memory coupled to the processor, the memory containing instructions, that when executed by the processor, cause the electronic computation device to:
determine a data generation temporal pattern;
create a data collection strategy based on the data generation temporal pattern;
generate a data collection policy based on the data collection strategy and a data infrastructure evaluation; and
create a data transfer schedule for transfer of data from one or more data source devices to a data store based on the data collection policy.

20. A computer program product for an electronic computation device comprising a computer readable storage medium having program instructions embodied therewith, the program instructions executable by a processor to cause the electronic computation device to:
determine a data generation temporal pattern;
create a data collection strategy based on the data generation temporal pattern;
generate a data collection policy based on the data collection strategy and a data infrastructure evaluation; and
create a data transfer schedule for transfer of data from one or more data source devices to a data store based on the data collection policy.
